(19) United States
(12) Patent Application Publication
(10) Pub. No.: US 2026/0278658 A1
(43) Pub. Date: Sep. 17, 2026

(54) USER MODELING AND PERSONALIZED PRODUCT RECOMMENDATION SYSTEM AND METHOD

(71) Applicant: BORUSAN MAKINA VE GUC SISTEMLERI SANAYI VE TICARET ANONIM SIRKETI, Istanbul (TR)

(72) Inventors: Esra AKCA, Istanbul (TR); Yasin DINC, Istanbul (TR); Nermin YALCI, Istanbul (TR)

(73) Assignee: BORUSAN MAKINA VE GUC SISTEMLERI SANAYI VE TICARET ANONIM SIRKETI, Istanbul (TR)

(21) Appl. No.: 19/166,875

(22) PCT Filed: Mar. 20, 2024
(86) PCT No.: PCT/TR2024/050278

§ 371 Date: Sep. 19, 2025

(30) Foreign Application Priority Data
Mar. 21, 2023 (TR) 2023/003068

(51) Int. Cl. G06Q 30/0601; G06Q 10/087

(52) U.S. Cl. CPC G06Q 30/0631; G06Q 10/08774

(57) ABSTRACT

The invention relates to a recommendation system (100) and method (200) where personalized recommendation clusters are computed by querying streaming data for flow-based recommendation systems used in the machinery and power systems sector, and these recommendations are presented to the user.

### TECHNICAL FIELD

The invention relates to a recommendation system and method where personalized recommendation clusters are computed by querying streaming data for flow-based recommendation systems used in the machinery and power systems sector, and these recommendations are presented to the user.

### STATE OF THE ART

In the known state of the art, the volume of users, services, and online information is rapidly increasing, leading to a big data analysis problem for recommendation systems. Traditional service recommendation systems often encounter scalability and inefficiency issues when processing or analyzing such large-scale data. Additionally, most existing service recommendation systems present the same service ratings and rankings to different users without considering the preferences of different users. Therefore, they fail to meet the personalized needs of users.

Recommendation systems match users who follow similar or identical types of content. Subsequently, they recommend each user's preferences to other users who have common product/service preferences. These queries involve relational algebra and data mining operations. Each user's interaction with each item is directly included based on the interaction made at time T. The advantage of the community strategy is that the system continuously adapts to changes in user behavior. The system's server part models and stores user preferences and enables the creation of a recommendation list between users. It is developed to determine cross-selling recommendations based on a user's past and present interactions and to provide real-time feedback.

On the other hand, as speed is becoming increasingly important on the internet, traditional recommendation systems are unable to respond quickly to changes in user preferences and track users' interests in real time.

In the patent document US2021294832 (A1); systems and methods for identifying similarities in content preferences among a large number of users and generating content recommendations based on the content consumption history of a requesting user are described. A requesting user can access the recommendation system to request content items for consumption. The recommendation system can be configured to identify users who have consumed the same or similar content items as the requesting user and to determine the ratio of content items consumed by the requesting user and a defined user to the total number of content items previously consumed by the requesting user. Unlike the patent document US2021294832 (A1), this invention aims to provide a need-targeted recommendation system by solving the problems in traditional recommendation systems.

In the patent document CN114048389B a content recommendation method and system for the engineering machinery industry are discussed. The method consists of the following steps: first, deciding whether a target user is a new user or an old user, then randomly recommend the hotspots and current news of the engineering machinery industry to the new user, and then process the new user and the old user together; collecting the behavior data of new and old users on a platform, obtaining a set of high-frequency keywords based on the behavior data, deleting keywords whose click conversion coefficients and reach depth coefficients do not reach an average value, and mining the preferences of new and old users based on their click conversion rates and dwell times to obtain a user preference set; and finally, using a Pearson correlation coefficient formula to find other users with high similarity with the target user's preference and recommend the target user's preference in the users' preference set to the target user, thus realizing personalized recommendation for different users and solving the problem that personalized recommendation for users in the prior art cannot be realized.

In general, recommendation systems are based on user satisfaction and liking in the marketing and advertising sector; they are not designed for needs. In the literature, there is no example of an application for need estimation in the construction equipment sector.

In the known state of the art, new methods need to be developed against the methods used to create recommendations in data volume recommendation systems. Evaluating a service on multiple criteria and taking user feedback into account will help to make more effective recommendations for users.

### OBJECTIVES AND BRIEF DESCRIPTION OF THE INVENTION

The purpose of the invention is to implement a recommendation system and method where personalized recommendation clusters are computed by querying streaming data for flow-based recommendation systems used in the machinery and power systems sector, and these recommendations are presented to the user.

In addition, the item to be purchased according to the user's needs is suggested by the invention. Finding the product easily and discovering new products suitable for the preferences of the user is made easier for the user with these systems.

Another purpose of the invention is to increase the satisfaction and loyalty of users with product recommendations, and to contribute to the increase in sales of companies with the right marketing strategies. Thus, time and labor savings are achieved.

On the other hand, the invention prevents unnecessary sales costs as the user will be contacted with the right product. In addition, in parallel with the prediction of user preferences, the invention reduces stock costs by determining adequate stocks.

To achieve the above objectives, the invention is a recommendation system that provides spare part recommendations to users in the machinery and power systems sector, comprising:
at least one database containing spare part and machine model information belonging to the user,
at least one preprocessing layer that filters out non-qualitative data such as parts for machines not in the customer's fleet, consumables (oil, wiper fluid), etc., from the database, thereby separating qualitative data like spare part information for machines in the customer's fleet,
at least one algorithm layer that selects the appropriate machine learning algorithm for the qualitative data obtained from the preprocessing layer and performs the algorithm calculations,
at least one storage layer that filters the results produced by the algorithm layer according to general recommendation, material suggestion, and basket suggestion rules, updates the calculation results based on the customer's real-time actions on the application, and consequently recommends the necessary spare part to the users.

The method of operation of a recommendation system to provide spare part recommendations to users in the machinery and power systems sector, wherein, involves the following steps,
collecting spare part and machine model information belonging to the user in a database,
filtering out non-qualitative data by a preprocessing layer from the database and transmitting qualitative data to an algorithm layer,
processing of qualitative data by the algorithm layer, training of the model, and determination of suitable algorithms,
running the determined algorithm in the algorithm layer and transmitting the results to a storage layer,
filtering the results produced by the algorithm layer according to different application rules of the storage layer and updating the calculation results to recommend the necessary spare part to the users.

### BRIEF DESCRIPTION OF FIGURES

FIG. 1. The system components related to the recommendation system of the invention and the relationships between them can be seen.

FIG. 2. A flow diagram illustrating the process steps of the method related to the invention is provided.

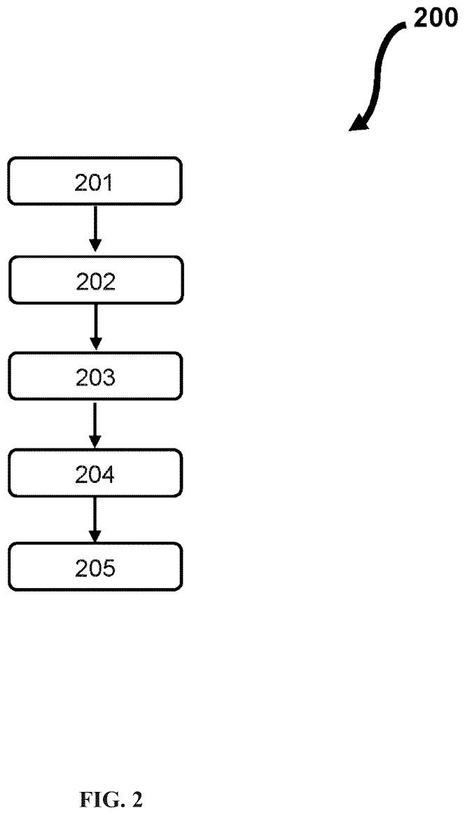

### REFERENCE NUMBERS

100. Recommendation System
10. Data Base
20. Preprocessing Layer
30. Algorithm Layer
40. Storage Layer
200. Method
201. Collecting spare part and machine model information belonging to the user in a database
202. Filtering out non-qualitative data by the preprocessing layer from the database and transmitting qualitative data to the algorithm layer
203. Processing of qualitative data by the algorithm layer, training of the model, and determination of suitable algorithms
204. Running the determined algorithm in the algorithm layer and transmitting the results to the storage layer
205. Filtering the results produced by the algorithm layer according to different application rules of the mentioned storage layer and updating the calculation results to recommend the necessary spare part to the users

### DETAILED DESCRIPTION OF THE INVENTION

The present invention discloses a recommendation system (100) developed to recommend the machinery and/or spare parts needed by the user in the machinery and power systems sector, and the recommendation method (200) of this system. With the mentioned recommendation system (100) and recommendation method (200), a solution is obtained where personalized recommendation clusters are calculated by querying streaming data used in existing flow-based recommendation systems in the prior art, and these recommendations are presented to the user.

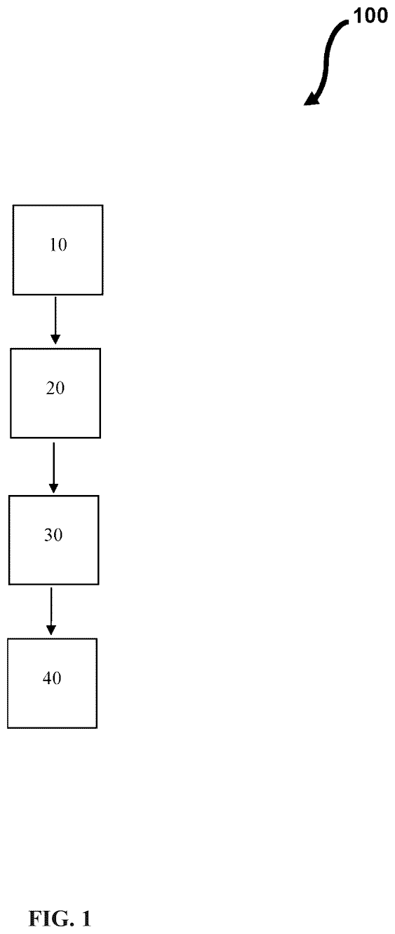

The system components related to the invention and the relationship between them are seen in FIG. 1. The recommendation system (100) comprises
at least one database (10) containing spare part and machine model information belonging to the user,
at least one preprocessing layer (20) that filters out non-qualitative data such as parts for machines not in the customer's fleet, consumables (oil, wiper fluid), etc., from the database (10), thereby separating qualitative data like spare part information for machines in the customer's fleet,
at least one algorithm layer (30) that selects the appropriate machine learning algorithm for the qualitative data obtained from the preprocessing layer (20) and performs the algorithm calculations,
at least one storage layer (40) that filters the results produced by the algorithm layer (30) according to general recommendation, material suggestion, and basket suggestion rules, updates the calculation results based on the customer's realtime actions on the application, and consequently recommends the necessary spare part to the users.

The mentioned preprocessing layer (20) requires the implementation of certain steps to ensure that the data can be processed and analyzed correctly. One of these steps is the filtering of qualified and unqualified data within the preprocessing layer (20).

Qualified data are those that are important for analysis and affect the analysis results. For example, data such as spare parts and additional equipment for machines in the customer's fleet are considered qualified data.

Unqualified data, on the other hand, are those that are irrelevant to the analysis or do not affect the analysis results. For instance, data such as screws and bolts, gaskets, windshield washer fluid, motor and hydraulic oils are considered unqualified data.

The process of filtering qualified and unqualified data in the preprocessing layer (20) separates the qualified and unqualified data in the data set to be analyzed, determining the data necessary for analysis. This process reduces the size of the data set, speeds up the analysis process, and improves the accuracy of the analysis results.

To perform this process, filtering, transformation and merging processes appropriate to the characteristics of the data and analysis purposes can be used. For example, filtering can be applied to identify and remove unqualified data in a data set. Transformation operations are used to determine data whose quality does not have a certain limit, and merging operations are used to combine data from different data sources.

The operating method (200) of the recommendation system (100) comprises the following steps;
collecting spare part and machine model information belonging to the user in a database (10) (201),
filtering out non-qualitative data by a preprocessing layer (20) from the database (10) and transmitting qualitative data to an algorithm layer (30) (202),
processing of qualitative data by the algorithm layer (30), training of the model, and determination of suitable algorithms (203),
running the determined algorithm in the algorithm layer and transmitting the results to a storage layer (40) (204),
filtering the results produced by the algorithm layer (30) according to different application rules of the storage layer (40) and updating the calculation results to recommend the necessary spare part to the users (205).

In the mentioned storage layer (40), different applications, collaborative filtering and content-based methods are used to develop a recommendation system (100) for similar preferences for users with similar characteristics. In the collaborative filtering method, similarities are calculated using Pearson correlation coefficient method. The contentbased recommendation system (100) is fed with user, product, invoice, stock, spare parts and technical specifications of the machines and recommendations are made in the form of appropriate parts for the appropriate machine. Real-time recommendations are provided by determining the changing number of users and products and the content shift situations that may occur in user preferences. These filtering applications are explained under 3 headings.

General Recommendation (Homepage): When entering the spare parts acquisition section, a recommendation system tailored to the user and based solely on their past purchases is utilized on the homepage. The items purchased in the user's recent shopping carts are combined using a recommendation system, and recommended materials are generated. These recommendations are then filtered based on the condition that they are compatible with the machines in the user's fleet, with the most recent transactions taking precedence.

Material Recommendation (Material Detail Page): When entering the detail page of items sold in the spare parts acquisition section, the “Material No” information of this material also comes as input to the recommendation system. In this recommendation system (100), it is filtered based on the logic of “What did users, who purchased this material, also buy in past sales?” From the items purchased together, those compatible with the machines in the user's fleet are selected as the final step.

Cart Recommendation (Cart Review Page): Similar to the material recommendation, in this section, the products that the user has added to the cart on the “My Cart” page, which is used to examine the details of the cart or to make the payment, are evaluated together and a recommendation is made based on this. Different materials will be suggested from the results of the material suggestion (both because there is not a single product in the input data and for the variety of recommendations). The materials in the cart and the materials purchased together (in past purchases) are extracted as a recommendation and a recommendation is presented by passing it through the user-fleet filter as a final control.

The recommendation system (100) continuously updates its model to capture user dynamics on the application and provide real-time recommendations. The algorithm layer in the invention uses user-item-time models to recommend based on the posterior probability distribution of user preferences. The quality and success of the recommendations provided in recommendation systems are directly related to the user profiles stored in the storage layer (40). To provide recommendations that meet users' expectations, it is necessary to have as much information about users as possible. It is based on the assumption that indirect feedback obtained through observing user behavior will more accurately reflect user preferences. Users are evaluated based on the industry segment they belong to. A more objective approach is used because the data is obtained directly through the analysis of user behavior. A relational data structure has been designed where data is aggregated in a format suitable for use by analytical models and reports. A recommendation model was designed to generate decision outcomes using the data stored in the database (10). The database (10) is a small data storage that is customized to the needs of a specific department or business function. Keeping the recommendation system up to date against factors such as changing user behavior and constantly renewed product range is the most important phenomenon of the positioning phase. Due to the high number of products and users, training the model requires high computing power and time. A solution was found in this case with the API architecture planned to be designed with the CI/CDI (Continuous Integration I Continuous Delivery & Deployment) approach.

What is claimed is:

1. A recommendation system (100) for use in the machinery and power systems industry to provide spare part recommendations to users, characterized by comprising
at least one database (10) containing spare part and machine model information belonging to the user,
at least one preprocessing layer (20) that filters out non-qualitative data such as parts for machines not present in the customer's fleet, consumables (oil, wiper fluid), etc., from the database (10), thereby separating qualitative data like spare part information for machines in the customer's fleet,
at least one algorithm layer (30) that selects the appropriate machine learning algorithm for the qualitative data obtained from the preprocessing layer (20) and performs the algorithm calculations,
at least one storage layer (40) that filters the results produced by the algorithm layer (30) according to general recommendation, material suggestion, and basket suggestion rules, updates the calculation results based on the customer's real-time actions on the application, and consequently recommends the necessary spare part to the users.

2. A recommendation method (200) for use in the machinery and power systems industry to provide spare part recommendations to users, characterized by comprising the steps of
collecting spare part and machine model information belonging to the user in a database (10) (201),
filtering out non-qualitative data by a preprocessing layer (20) from the database (10) and transmitting qualitative data to an algorithm layer (30) (202),
processing of qualitative data by the algorithm layer (30), training of the model, and determination of algorithms (203),
running the algorithm in the algorithm layer (30) and transmitting the results to the storage layer (40) (204),
filtering the results produced by the algorithm layer (30) according to different application rules of the storage layer (40) and updating the calculation results to recommend the necessary spare part to the users (205).
